(19) United States
(12) Patent Application Publication
(10) Pub. No.: US 2021/0398133 A1
(43) Pub. Date: Dec. 23, 2021

(54) USER IDENTITY RECOGNITION METHOD AND DEVICE, ELECTRONIC DEVICE AND STORAGE MEDIUM

(71) Applicant: BOE TECHNOLOGY GROUP CO., LTD., Beijing (CN)

(72) Inventor: Yanhua ZHU, Beijing (CN)

(73) Assignee: BOE TECHNOLOGY GROUP CO., LTD., Beijing (CN)

(21) Appl. No.: 17/281,861

(22) PCT Filed: May 26, 2020
(86) PCT No.: PCT/CN2020/092395

§ 371 Date: Mar. 31, 2021

(30) Foreign Application Priority Data
May 31, 2019 (CN) 201910470241.5

(51) Int. Cl. G06Q 20/40; G06K 9/00; G06F 21/31; G06F 21/32; G06Q 30/06

(52) U.S. Cl. CPC G06Q 20/40145; G06K 9/00288; G06Q 30/0631; G06F 21/316; G06F 21/32; G06K 9/00228

(57) ABSTRACT

The present disclosure provides a user identity recognition method, including: acquiring a user image; performing face recognition on the user image; and when a face image of a user has been detected in the user image and matches a face image of a special user, receiving operation behavior data of the user on a collection terminal, and associating the operation behavior data with a user identifier of the special user. The collection terminal is an operating device in a bank branch. The present disclosure further provides a user identity recognition device, an electronic device and a storage medium.

### CROSS-REFERENCE TO RELATED APPLICATION

The present application claims a priority of the Chinese patent application No. 201910470241.5 filed on May 31, 2019, which is incorporated herein by reference in its entirety.

### TECHNICAL FIELD

The present disclosure relates to a data processing method, in particular to a user identity recognition method, a user identity recognition device, an electronic device and a storage medium.

### BACKGROUND

Along with the advance of digitalization and informatization as well as the development of the mobile Internet technology, financial channels are diversifying and online finance are flourishing, so a marketing task becomes harder for an offline bank branch, and precision marketing becomes more and more important with respect to customers.

### SUMMARY

In a first aspect, the present disclosure provides in some embodiments a user identity recognition method, including: acquiring a user image; performing face recognition on the user image; and when a face image of a user has been detected in the user image and matches a face image of a special user, receiving operation behavior data of the user on a collection terminal, and associating the operation behavior data with a user identifier of the special user. The collection terminal is an operating device in a bank branch.

In a possible embodiment of the present disclosure, the collection terminal is a bank card sweeping device, a financial product exhibition device or a noble metal product exhibition device in the bank branch.

In a possible embodiment of the present disclosure, the performing the face recognition on the user image includes: determining whether there is the face image of the user in the user image; when there is the face image of the user in the user image, comparing the face image of the user with pre-stored face images; and when the face image of the user matches a face image of a special user, determining the user identifier of the special user as a user identifier of the user.

In a possible embodiment of the present disclosure, when the face image of the user has been detected in the user image, the user identity recognition method further includes tailoring the user image in accordance with a face position in the user image to reserve the face image of the user.

In a possible embodiment of the present disclosure, the user identity recognition method further includes: determining whether the special user is a user with a special identity in accordance with the user identifier of the special user; and when the special user is the user with a special identity, transmitting user information about the user with the special identity and the face image of the user to a designated terminal. The designated terminal is a preset terminal device that receives the user information about the user with the special identity and the face image of the user.

In a possible embodiment of the present disclosure, the user information is user information acquired after masking.

In a possible embodiment of the present disclosure, the user identity recognition method further includes: acquiring product data and historical operation behavior data associated with the user identifier of the special user; and generating a product recommendation content in accordance with the operation behavior data and the historical operation behavior data in combination with the product data.

In a possible embodiment of the present disclosure, the operation behavior data includes data generated when an operation behavior is made by the user on the collection terminal and/or the designated terminal, and the operation behavior includes one or more of queuing through swiping a bank card, viewing financial products, following financial products, purchasing financial products, viewing noble metal products, following noble metal products, and purchasing noble metal products.

In a possible embodiment of the present disclosure, the user identity recognition method further includes: receiving the operation behavior data of the user on the collection terminal and/or the designated terminal with respect to the product recommendation content; and generating a new product recommendation content in accordance with the operation behavior data of the user with respect to the product recommendation content in combination with the historical operation behavior data and the product data.

In a possible embodiment of the present disclosure, the user identity recognition method further includes, when the face image of the user fails to be detected in the user image and/or when the face image of the user does not match the face image of any special user, acquiring the user image continuously.

In a possible embodiment of the present disclosure, the user identity recognition method further includes, when the face image of the user fails to be detected in the user image after a predetermined time threshold and/or the face image of the user does not match the face image of any special user after the predetermined time threshold, stopping the acquisition of the user image.

In a possible embodiment of the present disclosure, the user identity recognition method further includes, when the face image of the user has been detected in the user image but does not match the face image of any special user, temporarily storing the face image of the user, receiving the operation behavior data of the user on the collection terminal, and associating the operation behavior data with the face image of the user.

In a possible embodiment of the present disclosure, the user identity recognition method further includes: receiving registration information about a new user; extracting a face image of the new user from the registration information about the new user; and when the face image of the new user matches the temporarily-stored face image of the user, associating the operation behavior data associated with the face image of the user with a user identifier of the new user.

In a second aspect, the present disclosure provides in some embodiments a user identity recognition device, including: a reception module configured to acquire a user image and receive operation behavior data of a user on a collection terminal; a face recognition module configured to perform face recognition on the user image; and an identity determination module configured to, when a face image of the user has been detected in the user image and matches a face image of a special user, associate the operation behavior data with a user identifier of the special user. The collection terminal is an operating device in a bank branch.

In a third aspect, the present disclosure provides in some embodiments an electronic device, including at least one processor, and a memory in communication connection with the at least one processor and storing therein an instruction executed by the at least one processor. The instruction is executed by the at least one processor so as to implement the above-mentioned user identity recognition method.

In a fourth aspect, the present disclosure provides in some embodiments a computer-readable storage medium storing therein a computer program. The computer program is executed by a processor so as to implement the steps of the above-mentioned user identity recognition method.

### BRIEF DESCRIPTION OF THE DRAWINGS

In order to illustrate the technical solutions of the present disclosure in a clearer manner, the drawings will be described hereinafter briefly. Obviously, the following drawings merely relate to some embodiments of the present disclosure, but shall not be construed as limiting the present disclosure.

FIG. 1a is a flow chart of a user identity recognition method according to one embodiment of the present disclosure;

FIG. 1b is another flow chart of the user identity recognition method according to one embodiment of the present disclosure;

FIG. 2 is a flow chart of a procedure of pushing user information and a face image with respect to a user with a special identity according to one embodiment of the present disclosure;

FIG. 3 is a flow chart of a procedure of recommending a product for a user according to one embodiment of the present disclosure;

FIG. 4 is a schematic view showing a user identity recognition device according to one embodiment of the present disclosure; and

FIG. 5 is a schematic view showing a device for implementing the user identity recognition method according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

In a first aspect, the present disclosure provides in some embodiments a user identity recognition method, so as to solve, to some extent, the problem in the related art where it is difficult to analyze a user behavior in a bank branch.

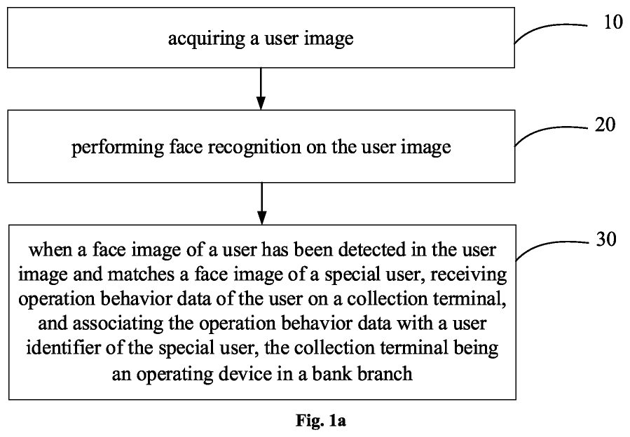

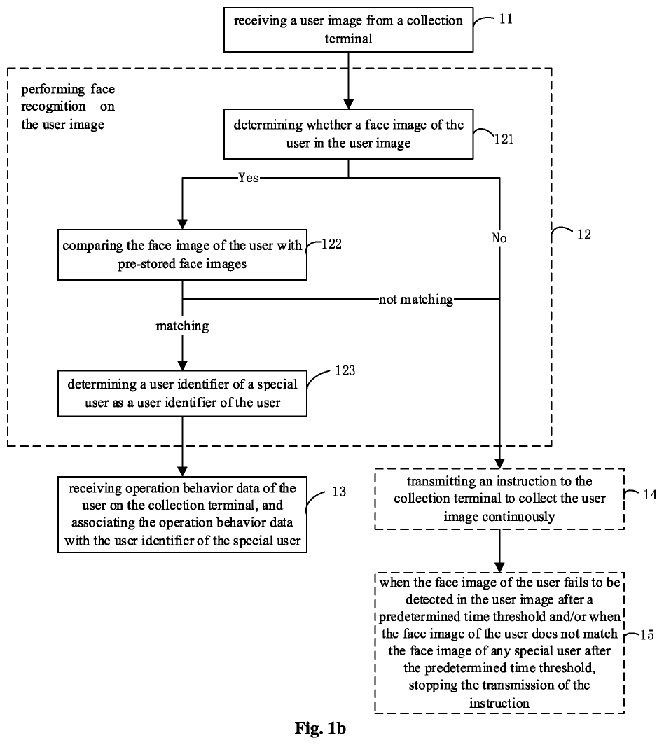

As shown in FIG. 1a, the user identity recognition method may be applied to a server or a terminal. When the user identity recognition method is applied to a collection terminal, the collection terminal is required to have a certain data processing capability. The user identity recognition method includes the following steps.

Step 10: acquiring a user image.

When the method is executed by a collection terminal, the collection terminal may acquire the user image, and when the method is executed by a server, the server may receive the user image from the collection terminal.

Step 20: performing face recognition on the user image.

Step 30: when a face image of a user has been detected in the user image and matches a face image of a special user, receiving operation behavior data of the user on a collection terminal, and associating the operation behavior data with a user identifier of the special user. The collection terminal is an operating device in a bank branch.

In the above scheme, the user image may be acquired and then the face recognition may be performed on the user image. When the face image of the user has been detected and matches the face image of the special user, the operation behavior data of the user on the collection terminal may be received, and the operation behavior data may be associated with the user identifier of the special user. In this regard, through the face recognition, the operation behavior data may be associated with the user identity, so as to recognize the user identity through an operation which should not be used to recognize the user identity, and collect and analyze a user behavior in accordance with the operation behavior data, thereby to solve, to some extent, the problem in the related art where it is difficult to analyze the user behavior in a bank branch. In addition, the user may be unaware of the recognition of the user identity through a user identity recognition device, so it is able to improve the user experience.

The following description will be given when the user identity recognition method is applied to a server. As shown in FIG. 1b, the user identity recognition method includes the following steps.

Step 11: receiving a user image from a collection terminal.

In a possible embodiment of the present disclosure, the collection terminal may be any operating device in a bank branch, e.g., a credit card device, a financial product exhibition device or a noble metal product exhibition device. The collection terminal may be provided with a collection unit (e.g., camera) for collecting an image of a user currently operating the collection terminal (i.e., the user image), so as to determine an identity of the user.

For example, the user may be any person who uses any operating device in the bank branch. The user may be a person who has already opened an account in the bank branch or the bank, or a person who has not opened an account in the bank branch or the bank.

In a possible embodiment of the present disclosure, a collection operation on the collection terminal may be triggered by an operation behavior of the user on the collection terminal. For example, when the operation behavior of the user has been detected by the collection terminal, the operation behavior may be transmitted to the server. Upon the receipt of the operation behavior of the user, the server may transmit a collection instruction to the collection terminal, so as to trigger the collection terminal to perform the collection operation, take the user image and transmit the user image to the server. Alternatively, after the operation behavior of the user has been detected, the collection terminal may directly start the collection operation, take the user image and transmit it to the server. The operation behavior of the user on the collection terminal may include, e.g., swiping a credit card or clicking a service item on the credit card device, or viewing a product content or selecting a product type on the financial product exhibition device or the noble metal product exhibition device, or viewing the other product or service on any other operating device in the bank branch.

In a possible embodiment of the present disclosure, the server may use a web service, each collection terminal may use a windows system, the collection terminals may communicate with each other via a Hyper Text Transport Protocol (http) Application Programming Interface (API), and the server may share data with the collection terminal through a database. In a possible embodiment of the present disclosure, the server may communicate with the collection terminal via a wired network.

Step 12: performing face recognition on the user image.

In a possible embodiment of the present disclosure, a face recognition function may be implemented using bottle (a lightweight python web framework which may be adapted to various web servers), and a face recognition algorithm SeetaFace (a face recognition framework) may be packaged in a service logic. The algorithm may include three parts, i.e., a face detection module, a face feature positioning module, and a face feature extraction and comparison module.

In a possible embodiment of the present disclosure, Step 12 of performing the face recognition on the user image may further include the following steps.

Step 121: determining whether there is the face image of the user in the user image, so as to determine whether a qualified user image, i.e., a user image sufficiently to perform face comparison, has been taken. For example, the user image may be an image of the user collected by the collection terminal, and the face image of the user may be a face image of the user acquired through face recognition in the user image.

Step 122: when the face image of the user has been detected in the user image, comparing the face image of the user with a pre-stored face image of a user. In a possible embodiment of the present disclosure, usually the pre-stored face image of the user is a face image recorded in a bank system when the user is registered as a bank client for the first time. The face image may be a face image collected during the registration, or a face image on an identity card when collecting identity card information about the user.

Here, similarities between the face image of the user and the pre-stored face images of different users may be calculated. When a similarity between the face image of the user and a face image of a special user is greater than a similarity threshold, the user may be determined as to be the special user, i.e., the face image of the user may match the face image of the special user. Of course, when similarities between the face image of the user and face images of a plurality of special users are greater than the similarity threshold, the special user with a greatest similarity may be determined as the user.

In a possible embodiment of the present disclosure, when the face image of the user fails to be detected in the user image, the method may skip to Step 14, i.e., transmitting an instruction to the collection terminal to collect the user image continuously, so as to collect the face image of the user capable of being used to perform the image comparison.

Step 123: when the face image of the user matches the face image of the special user, determining a user identifier of the special user as a user identifier of the user. In a possible embodiment of the present disclosure, the user identifier of the special user stored in the system may be bound to the user, so as to associate the operation behavior data of the user with operation behavior data of the special user.

The user identifier may include identity information about the user, e.g., an identity number. It may also include a nickname of the user (explanation of the user identifier).

Further, the user image may be tailored in accordance with a face position in the user image, so as to reserve the face image of the user for filing and subsequent use.

Here, in a possible embodiment of the present disclosure, the triggering the collection terminal to collect the user image and the tailoring the face image may be implemented through OpenCV (a Berkeley Software Distribution (BSD)-based, licensed (open source) cross-platform computer vision library).

In a possible embodiment of the present disclosure, when the face image of the user does not match the face image of the special user, the method may skip to Step 14, i.e., transmitting the instruction to the collection terminal to collect the user image continuously, so as to collect the face image of the user matching the face image of a certain special user.

In a possible embodiment of the present disclosure, Step 12 of performing the face recognition on the user image may be implemented in the collection terminal, apart from in the server. At this time, the collection terminal may communication with the server through an HTTP API.

Step 13: when the face image of the user has been detected in the user image and matches the face image of the special user, receiving the operation behavior data of the user on the collection terminal, and associating the operation behavior data with the user identifier of the special user.

It should be appreciated that, the operation behavior data may include data generated when an operation behavior is made by the user on the collection terminal and/or a designated terminal. The operation behavior may include one or more of queuing through swiping a bank card, viewing financial products, following financial products, purchasing financial products, viewing noble metal products, following noble metal products, and purchasing noble metal products.

In this regard, through associating the operation behavior data with the user identifier of the special user, it is able to analyze a corresponding behavior of the special user, so as to provide services for the user in a better manner.

In a possible embodiment of the present disclosure, the exhibition of the product through the collection terminal may be completed through a built-in windows desktop application. All key locations in the windows desktop application, e.g., a button for a list of various financial products, a button for details of each product, a “like” button, a “viewed” button and a “purchased” button, are provided with event tracking points. For example, when the user clicks a “viewing financial product” button, the application may transmit a request to the server. Upon the receipt of the request, the server may transmit an image collection request to the collection terminal, so as to trigger a built-in camera of the collection terminal to take an image. Features of the taken image may be compared with features of each image stored in a storage system through face recognition, so as to find a user identity (ID) (e.g., identity information). The user ID maybe transmitted by the server to the collection terminal, and the collection terminal may generate an operation behavior log of the user through a tracking function, and synchronize the operation behavior log to the server.

In a possible embodiment of the present disclosure, the user identity recognition method may further include Step 14 of, when the face image of the user fails to be detected in the user image and/or when the face image of the user does not match the face image of any special user, transmitting an instruction to the collection terminal so as to collect the user image continuously. In this regard, when the face image fails to be detected and/or the face image does not match the face image of any special user, the user image may be collected continuously so as to complete the face recognition and the matching of the user information.

In a possible embodiment of the present disclosure, the user identity recognition method may further include Step 15 of, when the face image of the user fails to be detected in the user image after a predetermined time threshold, and/or when the face image of the user does not match the face image of any special user after the predetermined time threshold, stopping the transmission of the instruction.

In a possible embodiment of the present disclosure, the user identity recognition method may further include the following step. When the face image of the user has been detected in the user image but the face image of the user does not match the face image of any special user, it means that a user corresponding to the user image currently collected by the collection terminal is not a user registered in the bank, so the server may temporarily store the face image of the user, receive the operation behavior data of the user on the collection terminal, and associate the operation behavior data with the face image of the user. In this regard, the face image of the unregistered user may be associated with its operation behavior data against unexpected needs.

It should be appreciated that, a prerequisite for the above-mentioned step is that the face image of the user has been detected in the user image but the face image of the user does not match the face image of any special user. This prerequisite overlaps a prerequisite for Step 14, but it does not mean that this step and Step 14 are mutually exclusive of each other. It should be appreciated that, when the prerequisites have been met, the server may temporarily store the face image of the user and receive the operation behavior data of the user on the collection terminal for association, and also transmit the instruction to the collection to collect the user image continuously. In other words, the two steps may be performed simultaneously, or one after another, so as to achieve the expected effect. These two steps may not be exclusive of each other within the capability of the server itself.

In a possible embodiment of the present disclosure, the user identity recognition method may further include: receiving registration information about a new user; extracting a face image of the new user from the registration information about the new user (e.g., the face image of the new user may be a face image on an ID card of the new user, or a face image of the new user collected by a camera at a bank counter during the registration); and when the face image of the new user matches the temporarily-stored face image of the user, associating the operation behavior data associated with the face image of the user with a user identifier of the new user.

In this regard, through the steps of temporarily storing the face image and associating the operation behavior data with the user identifier in conjunction with a subsequent step of comparing the face image of the new user in the registration information with the temporarily-stored face image, it is able to, after the registration, immediately associate the new user with the operation behavior data generated in the bank branch before the registration, thereby to provide the services for the new user in a better manner.

As can be seen from the above, according to the user identity recognition method in the embodiments of the present disclosure, the user image may be acquired and then the face recognition may be performed on the user image. When the face image of the user has been detected and matches the face image of the special user, the operation behavior data of the user on the collection terminal may be received, and the operation behavior data may be associated with the user identifier of the special user. In this regard, through the face recognition, the operation behavior data may be associated with the user identifier, so as to recognize the user identity through an operation which should not be used to recognize the user identity, and collect and analyze a user behavior in accordance with the operation behavior data, thereby to solve, to some extent, the problem in the related art where it is difficult to analyze the user behavior in the bank branch. In addition, in the user identity recognition method, it is able to accurately bind the user information and the user behavior through face recognition, with the user being unaware of the recognition of the user identity, thereby to improve the user experience.

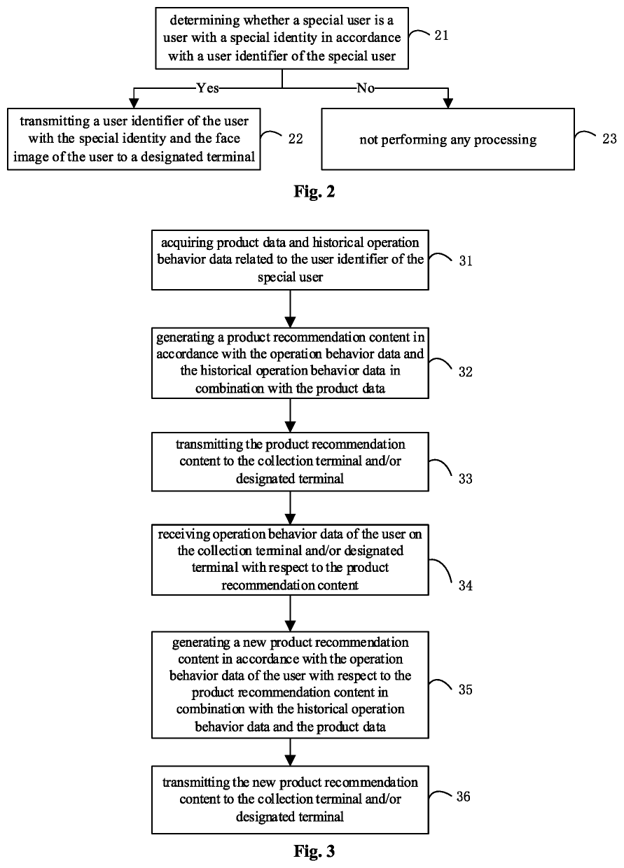

In a possible embodiment of the present disclosure, as shown in FIG. 2, the user identity recognition method may further include the following steps.

Step 21: determining whether the special user is a user with a special identity in accordance with the user identifier of the special user. Here, the user of the special identity may be a user with a special identity with respect to the bank or bank branch, e.g., a Very Important Person (VIP) for the bank or a user whose deposits exceed a certain number, or the user of the special identity may be a user who has a special identity and needs extra help, e.g., the aged, the disabled, or a soldier.

Step 22: when the special user is a user with a special identity, transmitting user information about the user with the special identity and the face image of the user to a designated terminal.

Through transmitting the user information about the user with the special identity and the corresponding face image to the designated terminal, a person with the designated terminal may provide services for the user with the special identity as soon as possible. The person with the designated terminal may rapidly acquire details of the user with the special identity in accordance with the user information, and find the user with the special identity conveniently in accordance with the face image. In a possible embodiment of the present disclosure, the designated terminal may be a preset terminal device for receiving the user information about the user with the special identity and the face image of the user, e.g., a handheld PAD (with an Android or IOS system) for a lobby manager. In a possible embodiment of the present disclosure, the handheld PAD may communicate with the server via Wireless Fidelity (WiFi).

In a possible embodiment of the present disclosure, the user information about the user with the special identity may also include a nickname of the user, and the face image of the user may also be a user picture acquired from a storage system.

In a possible embodiment of the present disclosure, the user information about the user with the special identity in Step 22 may be user information acquired after masking. Through the masking, it is able to prevent the leakage of the user information. The masking refers to data transformation on some sensitive information in accordance with a masking rule, so as to reliably protect the sensitive, private data. For security data of a customer or some sensitive business data, under the condition that a system rule is not broken, real data may be transformed for test. For example, such personal information as an ID number, a phone number, a card number or a customer number needs to be subjected to data masking. In a possible embodiment of the present disclosure, the user information may be acquired from a Customer Relationship Management (CRM) system of the bank. For example, in order to protect the user information, merely a part of the user information in the CRM system may be open to the server, and the user information acquired by the server from the bank may be user information that has been subjected to masking in the bank, so as to prevent the leakage of the user information stored in the bank. Hence, the user information capable of being acquired by the server from the CRM system has been subjected to masking. In other words, although merely the user information about the user with the special identity is subjected to masking as mentioned hereinabove, in some embodiments of the present disclosure, the user information about a normal user may also be subjected to masking, so as to prevent the leakage of the user information.

In addition, the bank merely provides a data interface for a part of user information to the server and the part of user information has been subjected to masking, so it is impossible for the server to directly acquire a specific user identifier from the collection terminal. The server needs to perform the face recognition on the user image so as to facilitate to determine a user identifier of a current user, thereby to associate the corresponding operation behavior data with the user identifier of the user.

In a possible embodiment of the present disclosure, the user information may include user data, property data, historical purchasing data, and financial product information of the user with the special identity.

In a possible embodiment of the present disclosure, an instance of the user information after masking may be {ID: 0010003, nickname: Mr. Zhang, property: somewhat rich, VIP or not: yes, and purchased products: [gold, fixed-term financial product, participating insurance]}.

Step 23: when the special user is a user with a normal identity, not performing any processing.

In the embodiments of the present disclosure, whether the special user is the user with the special identity may be determined in accordance with the user identifier of the special user, and when the special user is the user with the special identity, the user information about the user with the special identity and the face image of the user may be transmitted to the designated terminal, so as to enable a person with the designated terminal to provide services for the user with the special identity in time, thereby to improve the user experience of the user with the special identity.

In a possible embodiment of the present disclosure, as shown in FIG. 3, the user identity recognition method may further include the following steps.

Step 31: acquiring product data and historical operation behavior data associated with the user identifier of the special user.

In a possible embodiment of the present disclosure, the historical operation behavior data may be a historical record of the operation behavior data of the special user, and the historical record may be a record of the operation behavior data of the special user at each bank branch of the bank. In a possible embodiment of the present disclosure, the product data may be information and data related to various products provided by the bank, e.g., 7-day annualized return of a financial product, a product deadline, a product attribute, a product risk level, a transaction rule, a product feature, frequently asked questions, and details about property security assurance.

Step 32: generating a product recommendation content in accordance with the operation behavior data and the historical operation behavior data in combination with the product data.

In a possible embodiment of the present disclosure, a big data analysis platform may be set up using Cloudera Hadoop (CDH), and its assemblies may include Hadoop, Hive and Spark. Hadoop is a distributed file system for storing behavior log data, Hive is used for the storage of intermediate calculation results as well as interactive query, and Spark is used for memory calculation and data analysis.

In a possible embodiment of the present disclosure, in the step of generating the product recommendation content, a financial product suitable for the user may be generated through the big data analysis platform in accordance with profile data of the user (which is generated in accordance with basic identity information about the user), asset information, operation behavior data, historical operation behavior data, and data of available financial product.

Step 33: transmitting the product recommendation content to the collection terminal and/or the designated terminal.

In a possible embodiment of the present disclosure, when a collection terminal is currently being used by the user (a specific collection terminal may be determined in accordance with the user image collected by the collection terminal), the product recommendation content with respect to the user may be transmitted to the collection terminal, so that the user may immediately view the product content recommended specifically for the user. When a designated terminal is currently being used by the user (whether the designated terminal is currently being used by the user may be determined in accordance with the user image collected by the designated terminal), the product recommendation content with respect to the user may be transmitted to the designated terminal, so that the user may immediately view the product content recommended specifically for the user. In addition, the person with the designated terminal may introduce the product to the user accordingly.

In the embodiments of the present disclosure, the product recommendation content may be transmitted to the terminal used by the user. The product recommendation content may pop up on a screen, and the user may purchase the recommended product, so it is able to prevent the user from viewing the financial products aimlessly, market the product accurately, identify the user precisely, and achieve precision marketing, thereby to improve the operating efficiency of the bank branch.

In a possible embodiment of the present disclosure, as shown in FIG. 3, the user identity recognition method may further include the following steps.

Step 34: receiving the operation behavior data of the user on the collection terminal and/or the designated terminal with respect to the product recommendation content.

In a possible embodiment of the present disclosure, the operation behavior data of the user with respect to the product recommendation content may include viewing a product recommended in the product recommendation content (it means that the user is interested in the product recommendation content), or closing an interface of the product recommendation content (it means that the user is not interested in the product recommendation content).

Step 35: generating a new product recommendation content in accordance with the operation behavior data of the user with respect to the product recommendation content in combination with the historical operation behavior data and the product data. For example, when it is determined, in accordance with the operation behavior data of the user with respect to the product recommendation content, that the user is interested, not interested, in a certain product, a weight of this kind of product may be increased or decreased when recommending products, and then the new product recommendation content may be generated.

Step 36: transmitting the new product recommendation content to the collection terminal and/or the designated terminal.

The new product recommendation content may be generated in accordance with information reflected by the operation behavior data of the user with respect to the product recommendation content, so it is able to recommend products in a more accurate manner, and improve the user experience.

It should be appreciated that, the user identity recognition method for the server has been illustratively described hereinabove. However, apart from the server, the method may also be applied to any other device, as long as the device itself meets a corresponding hardware requirement. Hence, a scope of the present disclosure shall not be limited to the server.

In a second aspect, the present disclosure further provides in some embodiments a user identity recognition device, so as to solve, to some extent, the problem in the related art where it is difficult to analyze a user behavior in a bank branch.

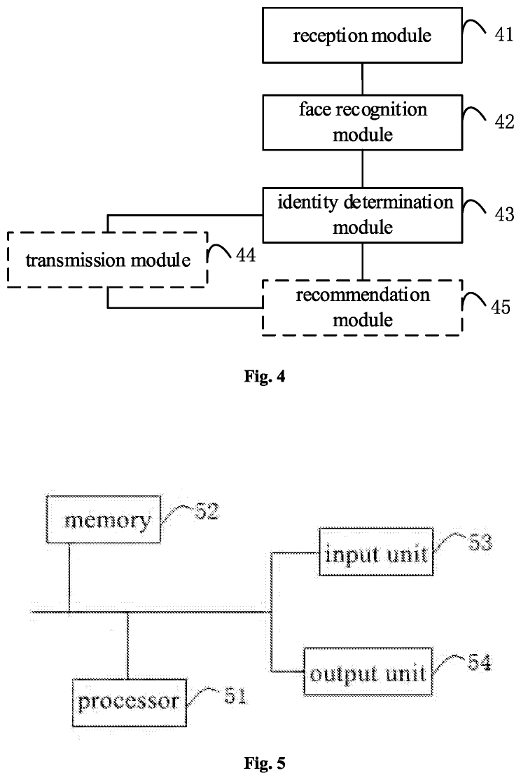

As shown in FIG. 4, the user identity recognition device includes: a reception module 41 configured to acquire a user image and receive operation behavior data of a user on a collection terminal; a face recognition module 42 configured to perform face recognition on the user image; and an identity determination module 43 configured to, when a face image of the user has been detected in the user image and matches a face image of a special user, associate the operation behavior data of the user on the collection terminal with a user identifier of the special user. The collection terminal is an operating device in a bank branch.

According to the user identity recognition device in the embodiments of the present disclosure, the user image may be acquired and then the face recognition may be performed on the user image. When the face image of the user has been detected and matches the face image of the special user, the operation behavior data of the user on the collection terminal may be received, and the operation behavior data may be associated with the user identifier of the special user. In this regard, through the face recognition, the operation behavior data may be associated with the user identifier, so as to recognize the user identity through an operation which should not be used to recognize the user identity, and collect and analyze a user behavior in accordance with the operation behavior data, thereby to solve, to some extent, the problem in the related art where it is difficult to analyze the user behavior in a bank branch. In addition, the user may be unaware of the recognition of the user identity through the user identity recognition device, so it is able to improve the user experience.

In a possible embodiment of the present disclosure, the face recognition module 42 is further configured to: determine whether there is the face image of the user in the user image; when there is the face image of the user in the user image, compare the face image of the user with pre-stored face images; and when the face image of the user matches a face image of a special user, determine the user identifier of the special user as a user identifier of the user.

In a possible embodiment of the present disclosure, the face recognition module 42 is further configured to tailor the user image in accordance with a face position in the user image to reserve the face image of the user.

In a possible embodiment of the present disclosure, the user identity recognition device further includes a transmission module 44. The identity determination module 43 is further configured to determine whether the special user is a user with a special identity in accordance with the user identifier of the special user. The transmission module 44 is configured to, when the special user is the user with a special identity, transmit user information about the user with the special identity and the face image of the user to a designated terminal. The designated terminal may be a preset terminal device that receives the user information about the user with the special identity and the face image of the user.

In a possible embodiment of the present disclosure, the user information about the user with the special identity may be user information acquired after masking.

In a possible embodiment of the present disclosure, the user identity recognition device may further include a recommendation module 45 configured to: acquire product data and historical operation behavior data associated with the user identifier of the special user; and generate a product recommendation content in accordance with the operation behavior data and the historical operation behavior data in combination with the product data.

In a possible embodiment of the present disclosure, the reception module 41 is further configured to receive the operation behavior data of the user with respect to the product recommendation content, and the recommendation module 45 is further configured to generate a new product recommendation content in accordance with the operation behavior data of the user with respect to the product recommendation content in combination with the historical operation behavior data and the product data.

In a possible embodiment of the present disclosure, when the face image of the user fails to be detected in the user image and/or when the face image of the user does not match the face image of any special user, the reception module 41 is further configured to acquire the user image continuously.

In a possible embodiment of the present disclosure, when the face image of the user fails to be detected in the user image after a predetermined time threshold and/or the face image of the user does not match the face image of any special user after the predetermined time threshold, the reception module 41 is further configured to stop the acquisition of the user image.

In a possible embodiment of the present disclosure, when the face image of the user has been detected in the user image but does not match the face image of any special user, the face recognition module is further configured to temporarily store the face image of the user, the reception module is further configured to receive the operation behavior data of the user on the collection terminal, and the identity determination module is further configured to associate the operation behavior data with the face image of the user.

In a possible embodiment of the present disclosure, the reception module is further configured to receive registration information about a new user. The face recognition module is further configured to extract a face image of the new user from the registration information about the new user. When the face image of the new user matches the temporarily-stored face image of the user, the identity determination module is further configured to associate the operation behavior data associated with the face image of the user with a user identifier of the new user.

The embodiments involving the user identity recognition device may correspond to the above-mentioned embodiments involving the user identity recognition method, and a technical effect of the embodiments involving the user identity recognition method will not be particularly defined herein.

In order to achieve the above purpose, in a third aspect, the present disclosure further provides in some embodiments a device for implementing the user identity recognition method. FIG. 5 shows a hardware structure of the device.

As shown in FIG. 5, the device includes one or more processors 51, and a memory 52. In FIG. 5, one processor 51 is taken as an example.

The device for implementing the user identity recognition method may further include an input unit 53 and an output unit 54.

The processor 51, the memory 52, the input unit 53 and the output unit 54 may be connected to each other via a bus or connected in any other way, and in FIG. 5, the bus is taken as an example.

As a nonvolatile computer-readable storage medium, the memory 52 may store therein nonvolatile software programs, nonvolatile computer-executable programs and modules, e.g., program instructions/modules corresponding to the above-mentioned user identity recognition method (e.g., the reception module 41, the face recognition module 42 and the identity determination module 43 in FIG. 4). The processor 51 is configured to execute the nonvolatile software programs, instructions and modules in the memory 52, so as to execute various functional applications of a server and data processing, i.e., to implement the above-mentioned user identity recognition method.

The memory 52 may include a program storage area and a data storage area. An operating system and an application desired for at least one function may be stored in the program storage area, and data created in accordance with the use of the electronic device for implementing the user identity recognition method may be stored in the data storage area. In addition, the memory 52 may include a high-speed random access memory, or a nonvolatile memory, e.g., at least one magnetic disk memory, a flash memory, or any other nonvolatile solid-state memory. In some embodiments of the present disclosure, the memory 52 may optionally include memories arranged remotely relative to the processor 51, and these remote memories may be connected to a registered member behavior monitoring device via a network. Examples of the network may include, but not limited to, Internet, Intranet, local area network, mobile communication network or a combination thereof.

The input unit 53 may receive digital or character information, and generate a key signal input related to user settings and function control of the user identity recognition device. The output unit 54 may include a display device, e.g., a display panel.

The one or more modules may be stored in the memory 52, and executed by the one or more processors 51 so as to implement the above-mentioned user identity recognition method, with a same or similar technical effect.

The present disclosure further provides in some embodiments a non-transient computer-readable storage medium storing therein a computer program to implement the above-mentioned user identity recognition method, with a same or similar technical effect.

It should be appreciated that, all or parts of the steps in the method may be implemented by related hardware under the control of a computer program. The computer program may be stored in a computer-readable storage medium, and it may be executed so as to implement the steps in the above-mentioned method embodiments. The storage medium may be a magnetic disk, an optical disk, a Read-Only Memory (ROM), or a Random Access Memory (RAM). A technical effect of the computer program may be the same as, or similar to, that of the above-mentioned method.

In addition, typically, the apparatuses or devices in the embodiments of the present disclosure may be various electronic terminal devices, e.g., mobile phone, Personal Digital Assistant (PDA), PAD, or intelligent television, or large-scale terminal devices, e.g., server, so the present disclosure shall not be limited to the device or apparatus of a specific type. The client in the embodiments of the present disclosure may be applied to any electronic terminal device in the form of electronic hardware, computer software or a combination thereof.

In addition, the method in the embodiments of the present disclosure may also be implemented as a computer program executed by a Central Processing Unit (CPU), and the computer program may be stored in a computer-readable storage medium. The computer program is executed by the CPU, so as to achieve the functions defined in the above-mentioned method.

In addition, the steps in the method and the system units may also be implemented through a controller, or through a computer-readable storage medium storing therein a computer program for enabling the controller to implement the above steps or functions.

It should be appreciated that, the computer-readable storage medium (e.g., memory) may be a volatile memory, a nonvolatile memory or both. Illustratively but nonrestrictively, the nonvolatile memory may be an ROM, a Programmable ROM (PROM), an Erasable PROM (EPROM), an electrically EPROM (EEPROM) or a flash memory. The volatile memory may be an RAM which serves as an external high-speed cache. Illustratively but nonrestrictively, the RAM may include Static RAM (SRAM), Dynamic RAM (DRAM), Synchronous DRAM (SDRAM), Double Data Rate SDRAM (DDRSDRAM), Enhanced SDRAM (ESDRAM), Synchronous Link DRAM (SLDRAM) or Direct Rambus RAM (DRRAM). The memory intends to include, but not limited to, the above-mentioned and any other appropriate memories.

It should be further appreciated that, the logic blocks, modules, circuitries and algorithm steps described herein may be implemented as electronic hardware, computer software or both. In order to clearly explain the interchangeability of hardware and software, the general description about functions of the illustrative assemblies, blocks, modules, circuitries and steps has been given. Whether these functions are implemented as software or hardware depends on a specific application and an entire system design constraint. The functions may be achieved in various ways with respect to a specific application, but the implementation shall not be construed as departing from the scope of the present disclosure.

The logic blocks, modules and circuitries described herein may be implemented or executed by the following members that are designed to achieve the functions: a general purpose processor, a Digital Signal Processor (DSP), an Application-Specific Integrated Circuit (ASIC), a Field Programmable Gate array (FPGA) or any other programmable logic element, a discrete gate or transistor logic element, a discrete hardware assembly, or a combination thereof. The general purpose processor may be a microprocessor, and alternatively, the processor may be any traditional processor, controller, microcontroller or state machine. The processor may also be implemented as a combination of computing devices, e.g., a combination of the DSP and the microprocessor, a plurality of microprocessors, a combination of one or more microprocessors and a DSP core, or the like.

The steps in the method or algorithm described herein may be directly included in hardware, a software module executed by a processor, or both. The software module may reside in an RAM, a flash memory, an ROM, an EPROM, an EEPROM, a register, a hard disc, a mobile disc, a Compact Disc-ROM (CD-ROM), or any other storage medium known in the art. The illustrative storage medium may be coupled to a processor, so that the processor may read information from the storage medium or write information into the storage medium. Alternatively, the storage medium may be integrated with the processor. The processor and the storage medium may reside in an ASIC, and the ASIC may reside in a user terminal. Alternatively, the processor and the storage medium may reside in the user terminal as discrete assemblies.

In one or more illustrative designs, the functions may be implemented in hardware, software, firmware or a combination thereof. When the functions are implemented in software, the functions may be stored in the computer-readable medium as one or more instructions or codes, or delivered via the computer-readable storage medium. The computer-readable medium may include a computer-readable storage medium and a communication medium, and the communication medium may include any medium accessible for a general-purpose or special-purpose computer. Illustratively but nonrestrictively, the computer-readable medium may include an RAM, an ROM, an EEPROM, a CD-ROM or any other optical disc, a magnetic disc or any other magnetic storage device, or any other medium for carrying or storing desired program codes in the form of instruction or data structure and accessible for a general-purpose or special-purpose computer or processor. In addition, any connection may be appropriately called as the computer-readable medium. For example, when software is transmitted by a website, server or any other remote source via a coaxial cable, an optical fiber, a twisted-pair cable, DSL, or a radio technology such as infrared, radio wave or microwave, the coaxial cable, the optical fiber, the twisted-pair cable, DSL, or the radio technology such as infrared, radio wave or microwave may also be included in the medium. As used here, the magnetic disc and the optical disc may include a CD, a laser disc, an optical disc, a Digital Video Disk (DVD), a floppy disc, or a blue-ray disc. Usually, the magnetic disc is configured to reproduce data magnetically, and the optical disc is configured to reproduce data optically through laser. The combination of the above contents shall also fall within the range of the computer-readable medium.

It should be further appreciated that, various alterations and modifications may be performed without departing from the scope of the present disclosure. The functions, steps and/or actions in the appended method claims do not need to be performed in any specific order. In addition, although each element in the embodiments of the present disclosure has been described or claimed in an individual manner, the quantity of the element may be plural, unless otherwise specified.

It should be appreciated that, unless otherwise defined, the singular form (“a”, “an” and “the”) is not intended to exclude a plurality of features and components. It should be further appreciated that, the expression “and/or” intends to include any of the listed terms as well as all possible combinations.

The serial numbers of the embodiments are for illustrative purposes only, but shall not be used to define that one embodiment is superior to the other.

It should be appreciated that, all of, or parts of, the steps may be implemented through hardware, or through hardware under the control of a program. The program may be stored in a computer-readable storage medium, and the storage medium may be an ROM, a magnetic disc or an optical disc.

The above embodiments are for illustrative purposes only, but shall not be construed as limiting the scope of the present disclosure (including the appended claims). Based on the concept of the present disclosure, the embodiments or the technical features in the embodiments may be combined, and for clarification, any other changes will not be provided in detail. Hence, any omission, modification, substitution and improvement made without departing from the spirit and principle of the present disclosure shall fall within the scope of the present disclosure.

1. A user identity recognition method, comprising:
acquiring a user image;
performing face recognition on the user image; and
when a face image of a user has been detected in the user image and matches a face image of a special user, receiving operation behavior data of the user on a collection terminal, and associating the operation behavior data with a user identifier of the special user, wherein the collection terminal is an operating device in a bank branch.

2. The user identity recognition method according to claim 1, wherein the collection terminal is a bank card sweeping device, a financial product exhibition device or a noble metal product exhibition device in the bank branch.

3. The user identity recognition method according to claim 1, wherein the performing the face recognition on the user image comprises:
determining whether there is the face image of the user in the user image;
when there is the face image of the user in the user image, comparing the face image of the user with pre-stored face images; and
when the face image of the user matches a face image of a special user, determining the user identifier of the special user as a user identifier of the user.

4. The user identity recognition method according to claim 3, wherein when the face image of the user has been detected in the user image, the user identity recognition method further comprises:
tailoring the user image in accordance with a face position in the user image to reserve the face image of the user.

5. The user identity recognition method according to claim 4, further comprising:
determining whether the special user is a user with a special identity in accordance with the user identifier of the special user; and
when the special user is the user with a special identity, transmitting user information about the user with the special identity and the face image of the user to a designated terminal,
wherein the designated terminal is a preset terminal device that receives the user information about the user with the special identity and the face image of the user.

6. The user identity recognition method according to claim 5, wherein the user information is user information acquired after masking.

7. The user identity recognition method according to claim 1, further comprising:
acquiring product data and historical operation behavior data associated with the user identifier of the special user; and
generating a product recommendation content in accordance with the operation behavior data and the historical operation behavior data in combination with the product data.

8. The user identity recognition method according to claim 7, wherein the operation behavior data comprises data generated when an operation behavior is made by the user on the collection terminal and/or the designated terminal, and the operation behavior comprises one or more of queuing through swiping a bank card, viewing financial products, following financial products, purchasing financial products, viewing noble metal products, following noble metal products, and purchasing noble metal products.

9. The user identity recognition method according to claim 7, further comprising:
receiving the operation behavior data of the user on the collection terminal and/or the designated terminal with respect to the product recommendation content; and
generating a new product recommendation content in accordance with the operation behavior data of the user with respect to the product recommendation content in combination with the historical operation behavior data and the product data.

10. The user identity recognition method according to claim 1, further comprising:
when the face image of the user fails to be detected in the user image and/or when the face image of the user does not match the face image of any special user, acquiring the user image continuously.

11. The user identity recognition method according to claim 10, further comprising:
when the face image of the user fails to be detected in the user image after a predetermined time threshold and/or the face image of the user does not match the face image of any special user after the predetermined time threshold, stopping the acquisition of the user image.

12. The user identity recognition method according to claim 10, further comprising:
when the face image of the user has been detected in the user image but does not match the face image of any special user, temporarily storing the face image of the user, receiving the operation behavior data of the user on the collection terminal, and associating the operation behavior data with the face image of the user.

13. The user identity recognition method according to claim 12, further comprising:
receiving registration information about a new user;
extracting a face image of the new user from the registration information about the new user; and
when the face image of the new user matches the temporarily-stored face image of the user, associating the operation behavior data associated with the face image of the user with a user identifier of the new user.

14. (canceled)

15. An electronic device, comprising at least one processor, and a memory in communication connection with the at least one processor and storing therein instructions executed by the at least one processor, wherein the instructions are executed by the at least one processor so as to implement the user identity recognition method according to claim 1.

16. A non-transitory computer-readable storage medium storing therein a computer program, wherein the computer program is executed by a processor so as to implement the steps in the user identity recognition method according to claim 1.

17. The electronic device according to claim 15, wherein the processor is further configured to:
determine whether there is the face image of the user in the user image;
when there is the face image of the user in the user image, compare the face image of the user with pre-stored face images; and
when the face image of the user matches a face image of a special user, determine the user identifier of the special user as a user identifier of the user.

18. The electronic device according to claim 17, wherein when the face image of the user has been detected in the user image, the processor is further configured to:
tailor the user image in accordance with a face position in the user image to reserve the face image of the user.

19. The electronic device according to claim 15, wherein the processor is further configured to:
determine whether there is the face image of the user in the user image;
when there is the face image of the user in the user image, compare the face image of the user with pre-stored face images; and
when the face image of the user matches a face image of a special user, determine the user identifier of the special user as a user identifier of the user.

20. The non-transitory computer-readable storage medium according to claim 16, wherein the performing the face recognition on the user image comprises:
determining whether there is the face image of the user in the user image;
when there is the face image of the user in the user image, comparing the face image of the user with pre-stored face images; and
when the face image of the user matches a face image of a special user, determining the user identifier of the special user as a user identifier of the user.

21. The non-transitory computer-readable storage medium according to claim 20, wherein when the face image of the user has been detected in the user image, the user identity recognition method further comprises:
tailoring the user image in accordance with a face position in the user image to reserve the face image of the user.
